(19) United States
(12) Patent Application Publication
(10) Pub. No.: US 2016/0230742 A1
(43) Pub. Date: Aug. 11, 2016

(54) Wind Turbine

(71) Applicant: Vijay Rao, Westport, CT (US)

(72) Inventor: Vijay Rao, Westport, CT (US)

(21) Appl. No.: 14/614,663

(22) Filed: Feb. 5, 2015

(51) Int. Cl. F03D 7/06; F03D 9/00; F03D 3/00

(52) U.S. Cl. CPC F03D 7/06; F03D 3/005; F03D 9/002

(57) ABSTRACT

A vertical-axis wind turbine mounts a plurality of wind-catching blades for rotation relative to two arms which sandwich each of the blades. A wind-directional vane provides a micro-processor data on the wind direction via a rotary encoder. In a first embodiment, a plurality of vane-position sensors and motors transmit and receive, respectively, information which adjusts the vane positions as a feedback loop. An alternate configuration utilizes home-position sensors which transmit the rotary displacement from the home position of each of the vanes to the micro-controller which keeps track of the respective vane positions and transmits repositioning information to the stepper motors to optimize energy extracted from the available wind currents by rotating the noses of the vanes to extend generally directly into the wind.

### BACKGROUND AND SUMMARY OF THE INVENTION

The present invention is directed to the field of alternative energy sources. More particularly, the present invention is a vertically-oriented wind turbine with electronic circuitry that maximizes the wind power that is converted to electricity.

With the world's supplies of fossil fuels being slowly, but steadily, depleted, efforts have turned to renewable energy including wind generators. Typically, wind generators take the form of gigantic propeller blades. In large-scale applications, the heavy inertial mass makes turning the windmill into the wind challenging. In some implementations, this is not possible. Propeller designs also have tips that travel at high velocities, inducing parasitic drag and tip vortices. Further, these propeller blades unwittingly kill thousands of migratory birds each year.

Vertical axis windmills are generally of the Panemone design. The Panemone design operates by inducing more drag on one side of the apparatus versus the other, hence inducing torque. As one side is used to fight and over-power the other side, this is not an efficient design either. Drag is not as effective as Lift for generating force.

Various other features, advantages, and characteristics of the present invention will become apparent after a reading of the following detailed description.

### BRIEF DESCRIPTION OF THE DRAWINGS

The preferred embodiment(s) of the present invention is/are described in conjunction with the associated drawings in which like features are indicated with like reference numerals and in which

FIG. 1 is a perspective side schematic of a first embodiment of the wind turbine of the present invention; and

FIG. 2 is a schematic diagram depicting the wiring connections for the first embodiment of the present invention.

### DETAILED DESCRIPTION OF THE PREFERRED EMBODIMENT(S)

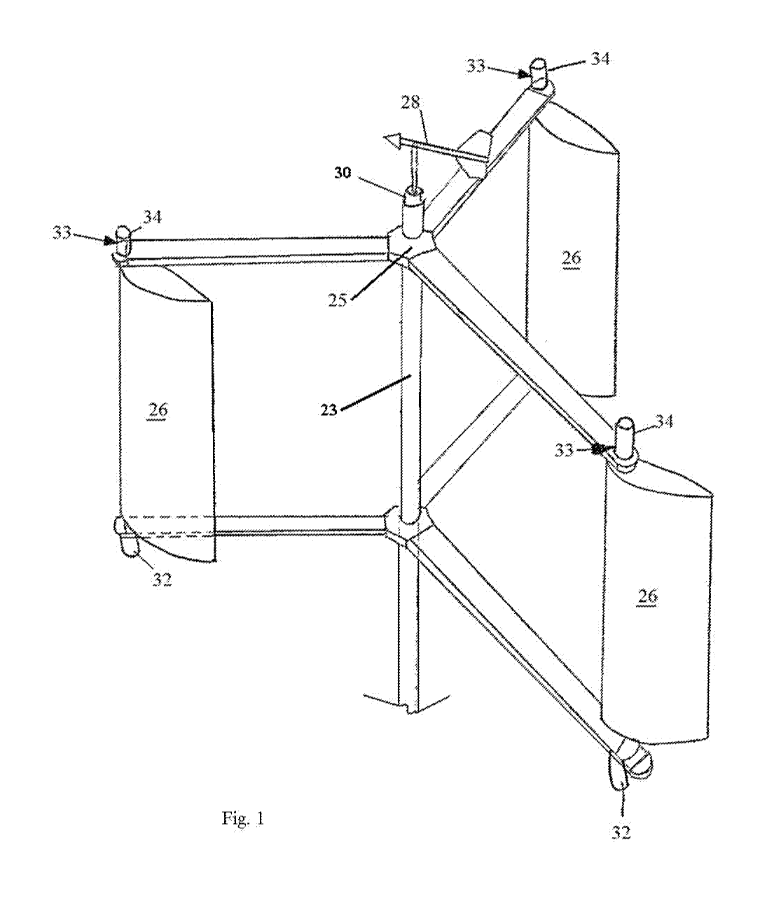

A first embodiment of the wind turbine of the present invention is depicted in FIG. 1 generally at 20. The wind turbine 20 of the present invention is designed to operated with the long axis (upon which central shaft 23 and central hub 25 lie) extending in the vertical direction. It will, however, be appreciated that were turbine 20 be utilized for harnessing ocean currents, some applications would afford optimal results by orienting the long axis horizontally. A rotatable cage is made up of a first plurality of arms 22 extending from central hub 25 and a second, like plurality of arms 24 extending essentially in a common vertical plane with first arms 22 to afford mountings for a third plurality of wind-catching vanes 26. Each vane 26 rotates upon axle 33, in a manner similar to the manner in which central hub 25 rotates upon central shaft 23.

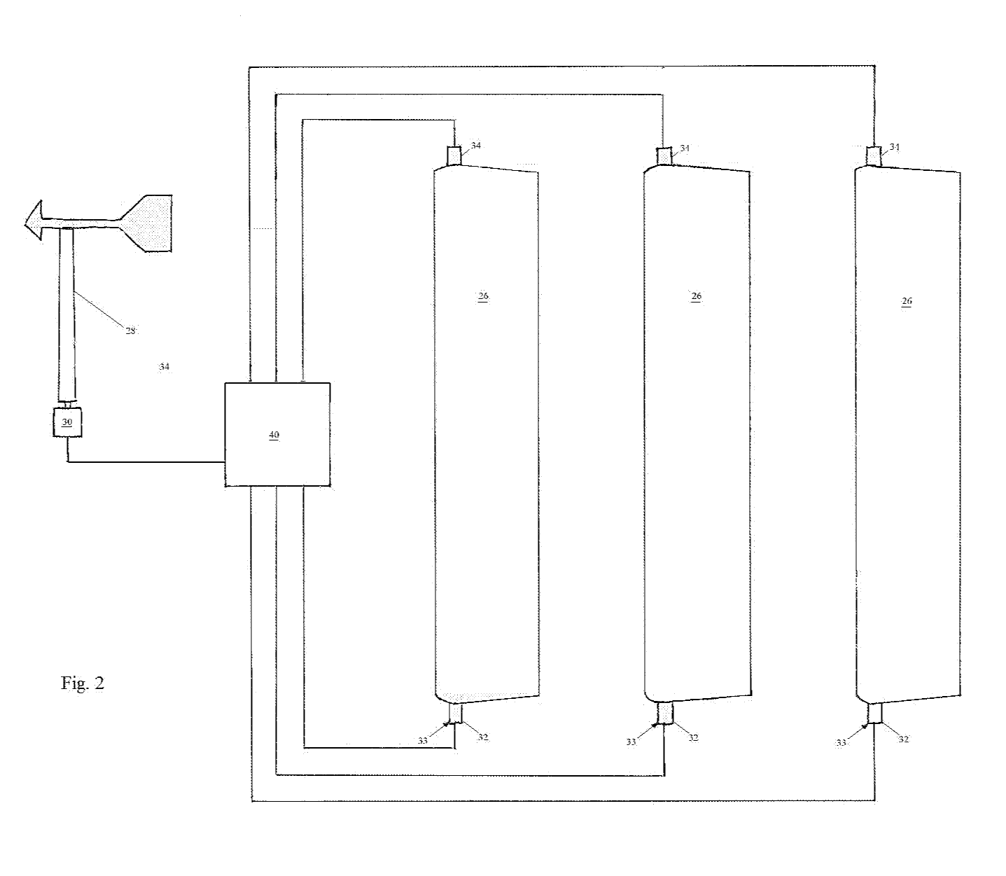

Wind-directional vane 28 is mounted in the vicinity of central shaft 23. Although FIG. 1 depicts vane 28 as being mounted atop shaft 23, it will be appreciated that it is only necessary that vane 28 being mounted close enough to shaft 23 so as to accurately reflect the wind direction in the region occupied by wind turbine 20. Rotary encoder 30 (FIG. 2) transmits a first data package regarding the wind-direction as determined by vane 28 to micro-controller 40. Rotary encoder 30 may take any of a variety of forms including a position sensor or angle sensor. Similarly, although the term “micro-controller” has been used, it will be appreciated that any of a variety of similar items could be substituted including, but not limited to, other electronic processors such as a micro-processor, a field programmable gate array (FPGA), or an application specific integrated circuit (ASIC). Each of the “connections” depicted in FIG. 2 are intended simply to indicate communication is established between the elements interconnected by the respective lines. While these elements may be interconnected via a hard wire connection, it is more likely, and preferred, that the communications be effected remotely, as by RF signal, or the like.

As best depicted in FIG. 2, each wind-catching vane 26 has a rotational motor 32 and a position sensor 34 associated therewith. Both the motors 32 and the sensors 34 may be internalized within the vanes 26 to protect them from environmental impact including dirt, weather, etc. Sensors 34 transmit a second data package comprised of positional information regarding each of the vanes 26 to micro-processor 40 and rotational motors 32 receive directives from the micro-processor. TABLE I depicts a flow chart of the steps of operation of the wind turbine of the present invention. In one preferred arrangement, rotary encoder 30, the motors 32, sensors 34, and micro-processor 40 comprise a simple feedback loop designed to maximize the lift the wind provides to the wind-catching vanes 26. Typically, this will occur when the nose of the vane 26 is positioned at an appropriate angle of attack relative to the on-coming wind as determined by the micro-processor 40. As an alternative, sensors 34 may each be a home position sensor and the motors 32 can be stepper motors. In this embodiment, the sensors 34 keep track of how far stepper motors 32 rotate vanes 26 from their home positions and micro-processor 40 stores the position information provided by home position sensors 34 and advises stepper motors 32 how far to turn vanes 28 in order to properly position them relative to the wind direction provided by rotary encoder 30.

Various changes, alternatives, and modifications will become apparent to a person of ordinary skill in the art after a reading of the foregoing specification. For example, although the Figures depict the number of vanes as 3, this is regarded as the minimum number necessary to function. The maximum number is limited only by the practicality of having a large number of spider arms extending from the central hub. It is intended that all such changes, alternatives, and modifications as fall within the scope of the appended claims be considered part of the present invention.

I claim:

1. A wind turbine for use in converting wind energy to electrical energy using a generator, said wind turbine comprising:
a. a central shaft;
b. a frame having a first plurality of arms extending from a central hub rotationally mounted on said central shaft and a second plurality of arms extending from said central hub in alignment with said first plurality of arms;
c. a wind-directional vane rotationally mounted in a vicinity of said central shaft;
d. a third plurality of wind-capturing panels rotationally mounted on and extending between said first plurality of arms and said second plurality of arms;
e. a feedback loop for gathering and transmitting a first data package concerning a relative direction of the wind and a second package of data concerning each relative position of each of said third plurality of wind-capturing panels;
f. a micro-controller for receiving said first and said second data packages, and processing said first and second data packages for controlling rotational positions of each one of said third plurality of wind-capturing panels to maximize energy gleaned from the wind.

2. The wind turbine of claim 1 wherein said feedback loop comprises
g. a rotary encoder associated with said wind-directional vane for sensing a rotational position of said wind-directional vane, forming said first data package, and transmitting said data package to a micro-controller;
h. a fourth plurality of rotary encoders, one said rotary encoder associated with each said wind-capturing panels, said fourth plurality of rotary encoders sensing data regarding a rotational position of each of said wind-capturing panels and transmitting said data to said micro-controller;
i. a fifth plurality of rotational motors associated with said wind-capturing panels, one of said fifth plurality of rotational motors being associated with each of said panels;
whereby said micro-controller receives said position data from said wind-directional vane encoder and from each of said fourth plurality of rotary encoders regarding respective positions of each one of said third plurality of wind-capturing panels and transmitting positioning data to said fifth plurality of motors in accordance with a program to optimize performance of said wind turbine.

3. The wind turbine of claim 2 wherein said first, second, third, fourth, and fifth pluralities are equal in number.

4. The wind turbine of claim 3 wherein said number is three.

5. The wind turbine of claim 2 wherein each of said rotary encoders for said wind-directional vane and said wind-capturing panels is capable of 360° rotational motion in either rotational direction.

6. The wind turbine of claim 1 wherein said feedback loop comprises
g. a home-position sensor for determining when each of said third plurality of wind-capturing vanes is in its basic home orientation;
h. a fourth plurality of stepper motors, one for each of said third plurality of wind-capturing vanes;
whereby said micro-controller records how many steps each of said stepper motors has traveled from its home position for each of said third plurality of wind-capturing vanes.

7. The wind turbine of claim 1 wherein said program for controlling said fifth plurality of motors
i) utilizes said data from said vane encoder to calculate an angular direction of said prevailing wind;
ii) utilizes said data from each of said fourth plurality of rotary encoders to calculate a rotary position of each of said wind-capturing panels;
iii) sends signals to said fifth plurality of motors to position each of said third plurality of wind-capturing panels to optimize performance of said wind turbine in accordance with a pre-programmed algorithm accounting for angular positions of said wind-capturing panels, rotational speed and wind speed, to maximize aerodynamic lift and rotational force transmitted to the generator.
